(19) United States
(12) Patent Application Publication
(10) Pub. No.: US 2024/0326768 A1
(43) Pub. Date: Oct. 3, 2024

(54) BRAKING SYSTEM FOR A MOTOR VEHICLE

(71) Applicant: Continental Automotive Technologies GmbH, Hannover (DE)

(72) Inventors: Harald Biller, Eschborn (DE); Thorsten Ullrich, Gernsheim (DE); Christian Courth, Frankfurt (DE); Tobias Scheller, Hofbieber (DE); Holger Schmidt, Wettenberg (DE)

(73) Assignee: Continental Automotive Technologies GmbH, Hannover (DE)

(21) Appl. No.: 18/577,876

(22) PCT Filed: Jun. 23, 2022
(86) PCT No.: PCT/DE2022/200138

§ 371 Date: Jan. 9, 2024

(30) Foreign Application Priority Data
Jul. 9, 2021 (DE) 10 2021 207 277.

(51) Int. Cl. B60T 13/74; B60T 13/68

(52) U.S. Cl. CPC B60T 13/745; B60T 13/686

(57) ABSTRACT

A brake system for a motor vehicle for hydraulically actuatable wheel brakes has a pressure medium reservoir, which has a first and second reservoir. A first port is assigned to the first reservoir chamber and a second port is assigned to the second reservoir chamber. The first and the second reservoir are at least partially separated from one another. An electrically activatable hydraulic pressure source formed by a cylinder-piston arrangement comprises a replenishment port for the replenishment of pressure medium from the pressure medium reservoir and an equalization port for hydraulically connecting a pressure space to the pressure medium reservoir when a piston is in a specified position. A pressure port of the pressure source is connected to hydraulic output ports of the wheel brakes. The replenishment port is connected via a replenishment valve to the first port and the equalization port is connected to the second port.

### TECHNICAL FIELD

The embodiments relate to a brake system.

### BACKGROUND

DE 10 2017 216 617 A1 has disclosed a brake system for four hydraulically actuatable wheel brakes, the brake system having one electrically actuatable inlet and outlet valve per wheel brake and having a pressure medium reservoir which has a first reservoir chamber and an associated first port and has a second reservoir chamber and an associated second port. In order to be suitable for highly automated driving and in order to be able to dispense with a mechanical and/or hydraulic fall-back level in which the driver can actuate the wheel brakes by manual force, the brake system comprises a first and a second electrically activatable hydraulic pressure source. The outlet valves of the brake system are connected via a return line to the first port of the pressure medium reservoir. The pressure space of the first pressure source is connected by means of a breather hole and a check valve and via a common replenishment line to the second port of the pressure medium reservoir.

### SUMMARY

An alternative brake system is provided and is suitable for highly automated driving, for a motor vehicle. The brake system may dispense with a mechanical and/or hydraulic fall-back level and nevertheless have a high level of availability, for example in the event of a leak, and thus provides sufficient safety for highly automated driving or an autopilot function. Furthermore, the brake system should be of the smallest possible structural size.

With regard to the brake system comprises a plurality of hydraulic output ports for hydraulically actuatable wheel brakes. A pressure medium reservoir is at atmospheric pressure and has a first reservoir chamber and a second reservoir chamber, wherein a first port of the pressure medium reservoir is assigned to the first reservoir chamber and a second port of the pressure medium reservoir is assigned to the second reservoir chamber, and wherein the first and the second reservoir chamber are at least partially separated from one another by a partition. An electrically activatable hydraulic pressure source which is formed by a cylinder-piston arrangement has a pressure space and a piston, wherein the piston can be pushed back and forth by means of an electric motor, wherein the pressure source comprises a replenishment port for the replenishment of pressure medium from the pressure medium reservoir and comprises an equalization port for hydraulically connecting the pressure space to the pressure medium reservoir when the piston is in a specified position. A pressure port of the pressure source is connected to the hydraulic output ports, wherein the replenishment port is connected via a replenishment valve to the first port of the pressure medium reservoir and the equalization port is connected to the second port of the pressure medium reservoir.

The availability of the brake system, for example in the event of a leak, is improved as a result of the separation of the replenishment port and first reservoir chamber, on the one hand, and equalization port and second reservoir chamber, on the other hand.

The brake system preferably comprises at least four hydraulic output ports for at least four hydraulically actuatable wheel brakes.

The brake system may comprise one electrically actuatable inlet valve per output port. The inlet valves are for example of normally open design.

The pressure port of the pressure source may be connected to a brake line portion to which the inlet valves are connected.

The brake system may comprise one electrically actuatable outlet valve per output port. The outlet valves may be of normally closed design.

The brake system may comprise a first electronic open-loop and closed-loop control unit and a second electronic open-loop and closed-loop control unit, wherein the electric motor of the pressure source can be activated by the first and the second electronic open-loop and closed-loop control unit. Since the electric motor of the pressure source, or the actuation thereof, is designed with redundancy, the brake system offers, in the event of a failure of one of the electronic open-loop and closed-loop control units, the electric motor of the pressure source can be activated by the other electronic open-loop and closed-loop control unit in order to provide a brake pressure for carrying out a service braking operation. Through the combination of a redundantly activatable pressure source and the special connection of the pressure source to the reservoir chambers of the pressure medium reservoir a brake system is provided which is suitable for highly automated driving, which has a high level of availability, for example in the event of a leak, and which is of small structural size.

In one embodiment of the brake system the pressure source and the electronic open-loop and closed-loop control units are configured such that, in the event of a failure of the first electronic open-loop and closed-loop control unit, the pressure source is activated by means of the second electronic open-loop and closed-loop control unit and builds up a pressure for actuating the wheel brakes, and such that, in the event of a failure of the second electronic open-loop and closed-loop control unit, the pressure source is activated by means of the first electronic open-loop and closed-loop control unit and builds up a pressure for actuating the wheel brakes.

In one embodiment of the brake system, the pressure source comprises a doubly wound electric motor having a first motor winding and a second motor winding, wherein the first motor winding is activated, for example exclusively, by the first electronic open-loop and closed-loop control unit, and the second motor winding is activated, for example exclusively, by the second electronic open-loop and closed-loop control unit. A second electrically activatable hydraulic pressure source can thus be dispensed with. Braking of the wheel brakes remains possible even after a single electrical or electronic fault. The doubly wound electric motor thus comprises a first motor winding and a second motor winding, wherein each of the two motor windings is activated by in each case one of the two electronic open-loop and closed-loop control units. In a certain sense, the electric motor is configured in two parts. If both motor windings are activated by both electronic open-loop and closed-loop control units, the electric motor delivers full power. If only one of the two electronic open-loop and closed-loop control units activates the corresponding motor winding, the pressure source can build up pressure, albeit at a reduced level and with reduced dynamics, with this pressure being applied to the wheel brakes. The vehicle can nevertheless be braked and brought to a standstill.

A spring of the replenishment valve may be dimensioned such that the replenishment valve cannot be opened by a hydrostatic pressure in the first reservoir chamber.

The equalization port may comprise a breather hole or to be designed as a breather hole. The pressure space of the pressure source may be connected via the breather hole to the second reservoir chamber of the pressure medium reservoir when the piston is in a non-actuated state, wherein the breather hole is closed, such that the hydraulic connection to the second reservoir chamber is shut off, when the piston is actuated.

The equalization port may be connected via a breather line portion to the second port of the pressure medium reservoir. The equalization port may be connected exclusively to the second port of the pressure medium reservoir. The breather line portion may not connected to the first port of the pressure medium reservoir.

For the replenishment of pressure medium into the pressure space of the pressure source, the pressure space may be hydraulically connected via the replenishment port and the replenishment valve to the first reservoir chamber of the pressure medium reservoir irrespective of the state of actuation of the pressure source.

The replenishment valve may be designed as a check valve that opens in the direction of the pressure space. Electrical activation is thus omitted.

The pressure space may be hydraulically connected to the second reservoir chamber of the pressure medium reservoir when the piston is in a non-actuated position. The specified position of the piston is thus a non-actuated position of the piston.

The outlet valves may be connected via a return line to the first port of the pressure medium reservoir, i.e., to the same port of the pressure medium reservoir as the replenishment port of the pressure source.

To reduce a number of bores in the valve block, the replenishment port may be connected via the replenishment valve to the return line. The replenishment port may be connected via the replenishment valve and an intake line portion to the return line.

In one embodiment of the brake system, no electrically actuatable valve, for example no valve, is arranged between the pressure space of the pressure source and each of the inlet valves. In this way, as compact a brake system is realized, and the number of electrically activatable valves is reduced.

Aside from the inlet and outlet valves, the brake system may not comprise any further electrically actuatable valves.

It may be the case that none of the inlet valves has a check valve connected in parallel, and none of the inlet valves comprises an integrated check valve.

In an alternative embodiment of the brake system, the pressure space of the pressure source is connected via an electrically actuatable, for example a normally open, isolating valve to the brake line portion to which the inlet valves are connected.

It may be the case that each of the inlet valves has a check valve connected in parallel, or each of the inlet valves comprises an integrated check valve.

The isolating valve may have a check valve connected in parallel, which check valve opens in the direction of the inlet valves. Pressure can thus be built up at the wheel brakes even if the isolating valve is erroneously in a closed state.

Each electrically activatable valve of the brake system may be actuated by the first electronic open-loop and closed-loop control unit.

The brake system may comprise a pressure sensor, for example only one pressure sensor, by means of which the pressure generated by the pressure source is determined. Further pressure sensors, for example for determining a wheel brake pressure, are not necessary. The pressure sensor may determine a pressure at the pressure source side of the inlet valves. The signals from the pressure sensor are supplied to, and evaluated by, the first electronic open-loop and closed-loop control unit. The pressure value of the pressure source is thus available to the electronic open-loop and closed-loop control unit, which also activates the inlet and outlet valves for the purposes of closed-loop control of the wheel brake pressures.

In one refinement, the brake system comprises redundant elements for detecting a rotational speed or a rotational angle of the electric motor, wherein the signals from one of the redundant elements are supplied to, and evaluated by, one electronic open-loop and closed-loop control unit, and the signals from the other redundant element are supplied to, and evaluated by, the other electronic open-loop and closed-loop control unit.

The brake system may comprise a first sensor for detecting a rotational angle or a rotational speed of the electric motor and an independent second sensor for detecting a rotational angle or a rotational speed of the electric motor, wherein the signals from the first sensor are supplied to, and evaluated by, the second electronic open-loop and closed-loop control unit, and the signals from the second sensor are supplied to, and evaluated by, the first electronic open-loop and closed-loop control unit.

The brake system may not comprise any further electrically activatable hydraulic pressure source.

The brake system may not comprise any further hydraulic pressure source. For example, the brake system does not comprise any hydraulic pressure source which is actuatable by means of a brake pedal, for example does not comprise any master brake cylinder which is actuatable by means of a brake pedal and which is connectable to the wheel brakes.

A supply may be provided to the brake system by a first electrical energy supply and by a second electrical energy supply that is independent of the first energy supply.

A supply may be provided to the first electronic open-loop and closed-loop control unit by a first electrical energy supply and a supply is provided to the second electronic open-loop and closed-loop control unit by a second electrical energy supply that is independent of the first energy supply.

The first electronic open-loop and closed-loop control unit and the second electronic open-loop and closed-loop control unit are electrically independent of one another in the sense that failure of the first electronic open-loop and closed-loop control unit does not cause failure of the second electronic open-loop and closed-loop control unit, and vice versa.

The electrically activatable hydraulic pressure source and the inlet and outlet valves may be arranged in a single hydraulic valve block.

The electrically activatable hydraulic pressure source, the inlet and outlet valves and the electronic open-loop and closed-loop control units are arranged in a single brake control device. The brake control device particularly preferably comprises the pressure sensor, the check valve and the first and the second sensor for detecting a rotational angle or a rotational speed of the electric motor.

In one refinement of the brake system, said brake system comprises an actuation unit for a vehicle driver, wherein the actuation unit is connected to at least one of the electronic open-loop and closed-loop control units for the transmission of a driver demand signal. Here, there is no mechanical-hydraulic connection between the actuation unit and the hydraulically actuatable wheel brakes (for example no hydraulic fall-back level).

The brake system preferably comprises a first electrically actuatable parking brake and a second electrically actuatable parking brake which are assigned to one vehicle axle, for example the rear axle, of the motor vehicle. It may be that the first electrically actuatable parking brake is actuated by the first electronic open-loop and closed-loop control unit and the second electrically actuatable parking brake is actuated by the second electronic open-loop and closed-loop control unit. A redundant parking brake function is achieved in this way.

### BRIEF DESCRIPTION OF THE DRAWINGS

Further embodiments will emerge from the dependent claims and the following description with reference to figures, in which, schematically:

FIG. 1 shows a first exemplary embodiment of a brake system; and

FIG. 2 shows a second exemplary embodiment of a brake system.

### DETAILED DESCRIPTION

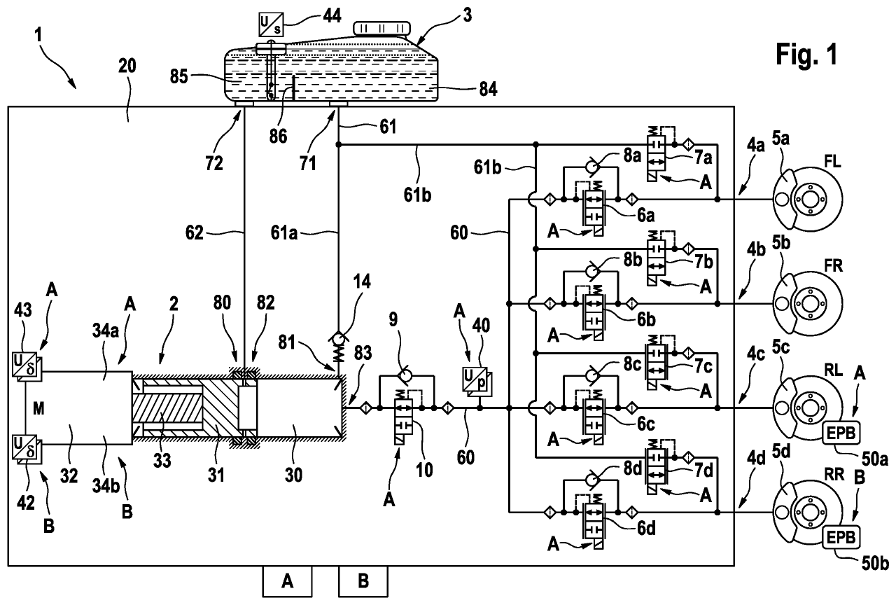

FIG. 1 schematically illustrates a first exemplary embodiment of a brake system 1 for a motor vehicle having four hydraulically actuatable wheel brakes 5a-5d.

The brake system 1 comprises a brake control device (HECU) having a hydraulic block 20 (hydraulic open-loop and closed-loop control unit HCU, valve block) that has one output port 4a-4d for each of the wheel brakes 5a-5d. A pressure medium reservoir 3 which is at atmospheric pressure is arranged on the valve block 20. According to the example, the output ports 4a, 4b are assigned to the wheel brakes 5a, 5b of the front axle (front), for example the output port 4a to the left front wheel FL (wheel brake 5a) and the output port 4b to the right front wheel FR (wheel brake 5b), and the output ports 4c, 4d are assigned to the wheel brakes 5c, 5d of the rear axle (rear), for example the output port 4c to the left rear wheel RL (wheel brake 5c) and the output port 4d to the right rear wheel RR (wheel brake 5d).

The fill level of the pressure medium reservoir 3 is measured by a fill level sensor 44.

The pressure medium reservoir 3 comprises at least two reservoir chambers 84, 85 which are at least partially separated from one another by a partition 86. The pressure medium reservoir 3 furthermore comprises a first port 71 and a second port 72. The first port 71 is connected to the first reservoir chamber 84, and the second port 72 is connected to the second reservoir chamber 85. In this context, a first port 71 of the pressure medium reservoir 3 is assigned to the first reservoir chamber 84, and the second port 72 of the pressure medium reservoir 3 is assigned to the second reservoir chamber 85.

Each output port 4a-4d is assigned an inlet valve 6a-6d and an outlet valve 7a-7d, wherein the inlet valves 6a-6d are of normally open design and the outlet valves 7a-7d are of normally closed design. According to the example, each inlet valve 6a-6d has a check valve 8a-8d connected in parallel, which check valve closes in the direction of the output port 4a-4d or wheel brakes 5a-5d.

The relevant output port 4a-4d is connected via the outlet valve 7a-7d to the pressure medium reservoir 3. The outlet valves 7a-7d are connected via an (at least partially common) return line 61b, 61 to the first port 71 of the pressure medium reservoir 3.

An electrically activatable hydraulic pressure source 2 is provided, which is formed by a cylinder-piston arrangement having a pressure space 30, the piston 31 of which cylinder-piston arrangement is actuatable by an electromechanical actuator having a schematically indicated electric motor 32 and having a schematically illustrated rotation-to-translation transmission 33. According to the example, the pressure source 2 is designed as a single-circuit electrohydraulic linear actuator (LAC) having only one pressure space 30. By means of the electromechanical actuator, the piston 31 can be pushed forward in order to build up a pressure (brake actuation direction) and pushed back or pulled back in order to dissipate a pressure.

According to the example, the electric motor is configured as a doubly wound electric motor 32 having a first motor winding 34a and a second motor winding 34b. If both motor windings 34a, 34b are activated, the electric motor 32 delivers full power. If only one of the two motor windings 34a, 34b is activated, although the power of the electric motor 32 is reduced, pressure can still be built up by means of the pressure source 2, albeit at a reduced level and with reduced dynamics.

The pressure space 30 is hydraulically connected via a pressure port 83 to a brake line portion 60 that is hydraulically connected to the inlet valves 6a-6d (more specifically to the input ports of the inlet valves 6a-6d). According to the example, an electrically actuatable, for example normally open, isolating valve 10 is arranged in the hydraulic connection between the pressure space 30 of the pressure source 2 and the brake line portion 60 or each of the inlet valves 6a-6d. According to the example, the isolating valve 10 has a check valve 9 connected in parallel, which check valve opens in the direction of the inlet valves 6a-6d or of the wheel brakes 5a-5d.

For the replenishment of pressure medium from the pressure medium reservoir 3 into the pressure source 2, the pressure source 2 has a replenishment port 81. The pressure space 30 is connected via the replenishment port 81 and a replenishment valve 14, which according to the example is designed as a check valve that opens in the direction of the pressure space 30, to the first port 71 of the pressure medium reservoir 3, and thus to the first reservoir chamber 84 of the pressure medium reservoir 3.

Furthermore, the pressure source 2 has an equalization port 82 for hydraulically connecting the pressure space 30 to the pressure medium reservoir 3 when the piston 31 is in a specified position. In this way, when the piston 31 is in the specified position, the wheel brakes 5a-5d can be depressurized, that is to say that the wheel brakes 5a-5d can be connected to the pressure medium reservoir 3, which is at atmospheric pressure. The specified position of the piston 31 may bethe non-actuated state of the piston 31. The equalization port 82 is connected to the other reservoir chamber 85, that is to say to the second port 72, of the pressure medium reservoir 3.

According to the example, the pressure source 2 has a breather hole 80 as the equalization port 82. The breather hole 80 is connected via a breather line portion 62 to the second port 72 of the pressure medium reservoir 3. When the piston 31 is in a non-actuated state, the pressure space 30 is connected via the breather hole 80 and the breather line portion 62 to the second reservoir chamber 85 of the pressure medium reservoir 3, wherein, when the piston 31 is actuated, the breather hole 80 is passed over/closed, and the connection to the pressure medium reservoir 3 is thus shut off. According to the example, the piston 31 is provided with at least one bore via which the hydraulic connection between the pressure space 30 and breather line portion 62 is established when the piston 31 is in the non-actuated state and which, when the piston 31 is actuated, passes over a seal such that the hydraulic connection between the pressure space 30 and the breather line portion 62 is shut off.

According to the example, the return line 61b, 61 for the outlet valves 7a-7d and an intake line 61a, 61 of the pressure source 2 are, in certain parts, formed in common. For this purpose, the replenishment port 81 is connected via the replenishment valve 14 and an intake line portion 61a to the return line 61b, 61. The outlet valves 7a-7d and the replenishment valve 14 are thus connected via a common line portion 61 to the first port 71 of the pressure medium reservoir 3. In other words, the intake line portion 61a and a return line portion 61b open into the line portion 61 to the first port 71. In this context, the pressure space 30 is connected via the replenishment valve 14 and the intake line portion 61a to the return line 61b, 61 (consisting of return line portion 61b and line portion 61).

The breather line portion 62 and the intake line portion 61a (or the return line 61b, 61 or the return line portion 61b or the line portion 61) are not directly connected to one another. Only a certain indirect hydraulic connection exists via the pressure medium reservoir 3 if the fill level of the pressure medium reservoir 3 lies above the partition 86.

The intake line 61a, 61 of the pressure source 2 is not connected to the second port 72 of the pressure medium reservoir 3.

Connected to the brake line portion 60 is a (system) pressure sensor 40, by means of which the pressure generated by the pressure source 2 can be determined. The pressure sensor 40 may be the only pressure sensor of the brake system 1 or of the brake control device.

For the activation of the pressure source 2, the brake system 1 comprises redundant sensor elements for detecting a rotational speed or a rotational angle of the electric motor 32. According to the example, a first motor angle sensor 43 and a second motor angle sensor 42 are provided.

The brake system 1 may comprise only the one hydraulic pressure source 2. The brake system 1 comprises neither a second electrically activatable hydraulic pressure source nor a pressure source that is actuatable by the driver, for example a master brake cylinder that is actuatable using a brake pedal, for the implementation of a hydraulic, driver-actuated fall-back level.

The brake system 1 furthermore comprises a first electronic open-loop and closed-loop control unit (ECU) A and a second electronic open-loop and closed-loop control unit (ECU) B for activating the electrically actuatable components of the brake system 1.

The first electronic open-loop and closed-loop control unit A and the second electronic open-loop and closed-loop control unit Bare electrically independent of one another in the sense that a failure of the first electronic open-loop and closed-loop control unit does not cause a failure of the second electronic open-loop and closed-loop control unit, and vice versa. For this purpose, the electronic open-loop and closed-loop control units A and B may be embodied as separate units, though they may also be embodied as independent subunits in the same electronic open-loop and closed-loop control unit.

The arrows A or B at the electrical or electrically actuatable components such as the valves 10, 6a-6d, 7a-7d and the sensors 40, 42, 43, 44 denote the assignment to the electronic open-loop and closed-loop control unit A or B.

The electric motor 32 of the pressure source 2 is activatable by the first and the second electronic open-loop and closed-loop control unit A, B, i.e., each of the electronic open-loop and closed-loop control units A, B is individually suitable for building up a brake pressure by means of the pressure source 2 for the purposes of carrying out a service braking operation. This means that the pressure source 2 and the electronic open-loop and closed-loop control units A, B are configured such that, in the event of a failure of the first electronic open-loop and closed-loop control unit A, the pressure source 2 can be activated by means of the second electronic open-loop and closed-loop control unit B in order to build up a brake pressure for actuating the wheel brakes 5a-5d during a service braking or normal braking operation, and such that, in the event of a failure of the second electronic open-loop and closed-loop control unit B, the pressure source 2 can be activated by means of the first electronic open-loop and closed-loop control unit A in order to build up a pressure for actuating the wheel brakes 5a-5d during a service braking or normal braking operation.

According to the example, the electric motor is designed as a doubly wound electric motor 32 having the first motor winding 34a and the second motor winding 34b. The electric motor 32 of the pressure source 2 is activated by the first and the second electronic open-loop and closed-loop control unit in the sense that the first motor winding 34a is activated, in particular supplied with electrical energy, by the first electronic open-loop and closed-loop control unit A (denoted by the arrow with A), and the second motor winding 34b is activated, in particular supplied with electrical energy, by the second electronic open-loop and closed-loop control unit B (denoted by the arrow with B). For this purpose, the motor winding 34a is connected to the first open-loop and closed-loop control unit A and the other motor winding 34b is connected to the second open-loop and closed-loop control unit B. For the activation of the pressure source 2, each of the two open-loop and closed-loop control units A, B comprises a motor processor for processing the motor control functions, an output stage with transistors for providing the phase voltages at the electric motor 32 (for example a B6 bridge), and a driver stage (gate drive unit) for activating the transistors of the output stage.

In the event of a failure of one of the electronic open-loop and closed-loop control units A or B, the pressure source 2 is activated by means of the other electronic open-loop and closed-loop control unit B or A, and a pressure is built up for actuating the wheel brakes 5a-5d in the brake-by-wire operating mode for service braking. The pressure source 2 or the electric motor 34 is operated at least with a proportion of its power by the one functional electronic open-loop and closed-loop control unit B or A in order to build up a pressure for actuating the wheel brakes.

The electrically actuatable inlet and outlet valves 6a-6d, 7a-7d, the isolating valve 10 and the sensors 40, 42, 43, 44 of the brake system 1 are each assigned to only one of the electronic open-loop and closed-loop control units. This means that each electrically actuatable valve 10, 6a-6d, 7a-7d is activated exclusively by the electronic open-loop and closed-loop control unit A or exclusively by the electronic open-loop and closed-loop control unit B. This avoids complex, doubly activatable valves/valve coils. The signals from each sensor 40, 42, 43 or 44 are supplied exclusively to the electronic open-loop and closed-loop control unit A or exclusively to the electronic open-loop and closed-loop control unit B.

All of the electrically actuatable valves, i.e., according to the example, the electrically actuatable inlet and outlet valves 6a-6d, 7a-7d and the isolating valve 10, are advantageously assigned to the same electronic open-loop and closed-loop control unit, according to the example the electronic open-loop and closed-loop control unit A, and are activated exclusively by the electronic open-loop and closed-loop control unit A.

The signals from the (first) motor angle sensor 43 are supplied to, and evaluated by, the second electronic open-loop and closed-loop control unit B, whereas the signals from the (second) motor angle sensor 42 are supplied to, and evaluated by, the first electronic open-loop and closed-loop control unit A.

The signals from the pressure sensor 40 are supplied to the same electronic open-loop and closed-loop control unit A that also activates the inlet and outlet valves 6a-6d, 7a-7d, i.e., according to the example, the signals from the pressure sensor 40 are supplied to, and evaluated by, the first electronic open-loop and closed-loop control unit A.

After a failure of one of the electronic open-loop and closed-loop control units A or B, the pressure source 2 can nevertheless be activated by means of one of the motor windings 34a or 34b and one of the motor angle sensors 42 or 43 (or optionally the pressure sensor 40), and a suitable pressure can thus be built up, albeit potentially at a reduced level and/or with reduced dynamics. This (central) pressure can be applied to all of the wheel brakes 5a-5d. The (central) pressure can also be modulated by virtue of the piston 31 being pushed back and forth.

A supply is provided to the brake system 1 by a redundant on-board electrical system having two independent voltage sources (a first electrical energy supply and a second electrical energy supply), such that the two open-loop and closed-loop control units A and B are not provided with a supply by the same electrical energy supply. For example, a supply is provided to open-loop and closed-loop control units A by the first electrical energy supply, and a supply is provided to open-loop and closed-loop control units B by the second electrical energy supply.

According to the example, the brake system 1 comprises electric parking brakes 50a, 50b at the wheels of one of the axles, for example at the rear wheels RL, RR. The electric parking brakes 50a, 50b are activated or actuated by the electrohydraulic brake control device.

The wheel brakes of the rear axle are designed as combination brake calipers having a hydraulic wheel brake 5c, 5d and an integrated, electrically actuatable parking brake (IPB).

According to the example, one of the electric parking brakes, for example parking brake 50a, is actuated/activated by the first electronic open-loop and closed-loop control unit A (this is denoted by the arrow with A), whereas the other of the electric parking brakes, for example parking brake 50b, is actuated/activated by the second electronic open-loop and closed-loop control unit B (this is denoted by the arrow with B). After a failure of one of the open-loop and closed-loop control units A or B, the vehicle can still be secured by at least one of the parking brakes, which is actuated by the functional open-loop and closed-loop control unit B or A. This eliminates the need for a transmission parking lock.

The brake system also comprises an actuation unit for a vehicle driver (not shown in FIG. 1). The actuation unit is connected to the brake control device (HECU) on the signal side for the purposes of transmitting a driver demand signal, but there is no mechanical-hydraulic connection between the actuation unit and the brake control device or the wheel brakes 55a-5d.

In the event of a failure of the second electronic open-loop and closed-loop control unit B, the hydraulic braking function of the brake system by means of the pressure source 2, including the closed-loop wheel pressure control by means of the inlet and outlet valves 6a-6d, 7a-7d, can be performed by the first electronic open-loop and closed-loop control unit A, the only limitation being, potentially, that the power of the pressure source 2 is reduced.

Since the outlet valves 7a-7d are normally closed and the inlet valves 6a-6d are normally open, all of the wheels can be hydraulically braked in the event of a failure of the first electronic open-loop and closed-loop control unit A. For this purpose, the second electronic open-loop and closed-loop control unit B, if no pressure signal is available to it, performs closed-loop control of the delivered pressure medium volume. Common pressure modulation at all wheel brakes 5a-5d remains possible.

When braking is not being performed, the wheel brakes 5a-5d should be at atmospheric pressure. For this purpose, the pressure source 2 is activated and returned to its non-actuated state such that a hydraulic connection is established via the breather hole 80 to the pressure medium reservoir 3, which is at atmospheric pressure.

When the outlet valves 7a-7d are used for wheel-specific closed-loop pressure control, pressure medium volume is consumed in the sense that pressure medium is discharged from the pressure space 30 via the wheel brakes 5a-5d into the pressure medium reservoir 3. Accordingly, a volume of pressure medium must be replenished into the pressure space 30 of the pressure source 2 via the replenishment valve 14 at the latest when the pressure medium volume in the pressure space 30 reaches a lower limit value.

In the valve block 20 of the brake system, there is no hydraulic connection between the replenishment port 81 and the second port 72 of the pressure medium reservoir 3, and there is no hydraulic connection between the equalization port 82 and the first port 71 of the pressure medium reservoir 3.

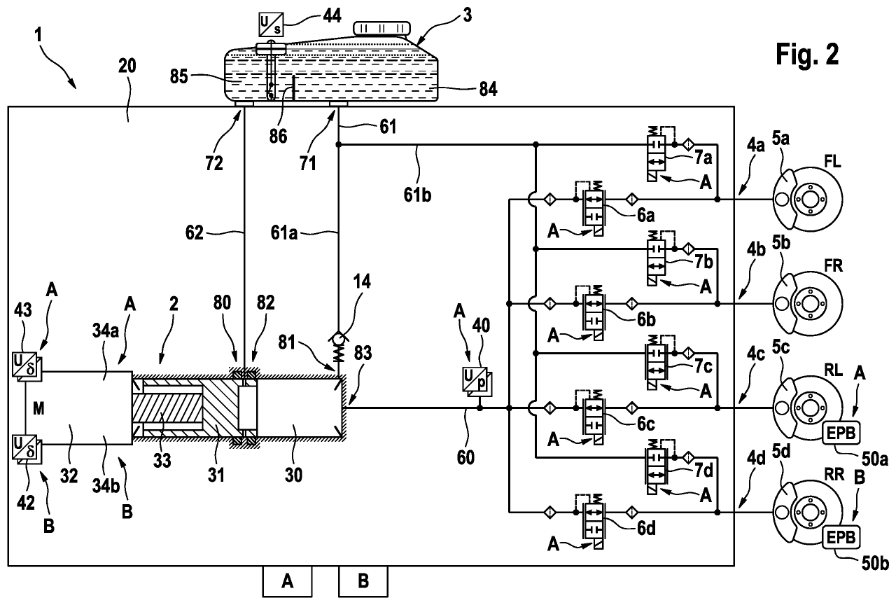

FIG. 2 schematically illustrates a second exemplary embodiment of a brake system 1 for a motor vehicle having four hydraulically actuatable wheel brakes 5a-5d. By contrast to the first exemplary embodiment in FIG. 1, no isolating valve 10, no check valve 9 and no check valves 8a-8d are provided. The pressure space 30 of the pressure source 2 is, as it were, hydraulically connected directly to the brake line portion 60 or to the inlet valves 6a-6d, that is to say, according to the example, no electrically actuatable valve 10 is provided. According to the example, no valve, not even a check valve, is arranged in the hydraulic connection between the pressure space 30 and each of the inlet valves 6a-6d. This offers low throttling losses in the main flow path from the pressure source 2 to the inlet valves 6a-6d and the wheel brakes 5a-5d.

Aside from the electrically actuatable inlet and outlet valves 6a-6d, 7a-7d, the brake system 1 according to the example in FIG. 2 does not comprise any further electrically actuatable valves.

In relation to a brake system having a pressure source such as is known for example from DE 10 2017 216 617 A1, in which both the breather line to the breather hole and the intake line having the replenishment valve are connected to the same port or the same reservoir chamber of the pressure medium reservoir, and the return line of the outlet valves is connected to the other port or the other reservoir chamber of the pressure medium reservoir. The brake system according to the present embodiments is operable in the event that an external leak occurs before or whilst the motor vehicle is parked, for example in the event of a leak at one of the wheel brakes or at the secondary collar of the pressure source/of the linear actuator.

In such a brake system having a pressure source according to the prior art, in this case, whilst the vehicle is parked, that reservoir chamber of the pressure medium reservoir which is connected to the pressure source will be completely drained under the influence of gravitational force, and also the linear actuator itself will at least partially fill with air. The hydraulic brake system thereafter cannot be operated, or can be operated only with significant limitations.

This problem also cannot be entirely eliminated by virtue of the linear actuator, when shut down, being parked in a position in which the breather hole is closed. Fluctuations in the ambient temperature can give rise to pressure fluctuations, and a shift of the linear actuator piston can gradually occur, such that the breather hole ultimately opens.

However, the described problem is eliminated in the brake systems according to the example by virtue of the two reservoir ports of the pressure source 2, the replenishment port 81 and the equalization port 82, and the connecting lines thereof to the pressure medium reservoir 3, being strictly separated. Here, one reservoir port, the replenishment port 81, serves during normal operation as a suction port, whereas the other reservoir port, the equalization port 82, establishes a connection to atmosphere in a particular motor position or piston position. These two reservoir ports of the pressure source 2 are connected to separate reservoir chambers 84, 85 of the pressure medium reservoir 3.

Now, if an external leak occurs whilst the vehicle is parked, that reservoir chamber 85 which is connected to the equalization port 82 and to the breather hole 80 duly drains, and the pressure source 2 or the pressure space 30 partially fills with air. However, that reservoir chamber 84 which is connected to the replenishment port 81 remains filled up to the level of the partition 86. Here, the spring of the replenishment valve 14 is dimensioned such that the replenishment valve 14 is not opened by the hydrostatic pressure. A supply of pressure medium thus remains available to the pressure source 2. Owing to the replenishment action of the pressure source 2, the pressure source 2 can generate as high a pressure as desired. The air that has infiltrated into the pressure source 2 can be purged via the outlet valves 7a-7d into the pressure medium reservoir 3, or said air escapes via the outlet valves 7a-7d as soon as these are opened during the course of a driving-dynamics-related wheel pressure modulation.

1. A brake system for a motor vehicle comprising:
a plurality of hydraulic output ports for hydraulically actuatable wheel brakes;
a pressure medium reservoir which is at atmospheric pressure and which has a first reservoir chamber and a second reservoir chamber, wherein a first port of the pressure medium reservoir is assigned to the first reservoir chamber and a second port of the pressure medium reservoir is assigned to the second reservoir chamber, and wherein the first and the second reservoir chamber are at least partially separated from one another by a partition;
an electrically activatable hydraulic pressure source which is formed by a cylinder-piston arrangement having a pressure space and a piston, wherein the piston can be pushed back and forth by means of an electric motor;
wherein the pressure source comprises a replenishment port for the replenishment of pressure medium from the pressure medium reservoir and comprises an equalization port for hydraulically connecting the pressure space to the pressure medium reservoir when the piston is in a specified position, wherein a pressure port of the pressure source is connected to the hydraulic output ports; and
wherein the replenishment port is connected via a replenishment valve to the first port of the pressure medium reservoir and the equalization port is connected to the second port of the pressure medium reservoir.

2. The brake system as claimed in claim 1, wherein said brake system comprises a first electronic open-loop and closed-loop control unit and a second electronic open-loop and closed-loop control unit, wherein the electric motor of the pressure source can be activated by the first and the second electronic open-loop and closed-loop control unit.

3. The brake system as claimed in claim 1, wherein the equalization port comprises a breather hole or is designed as a breather hole.

4. The brake system as claimed in claim 1, wherein the equalization port is connected via a breather line portion to the second port of the pressure medium reservoir.

5. The brake system as claimed in claim 4, wherein the breather line portion is not connected to the first port of the pressure medium reservoir.

6. The brake system as claimed in claim 1, wherein the replenishment valve is a check valve that opens in the direction of the pressure space.

7. The brake system as claimed in claim 1, wherein the pressure space is hydraulically connected to the second reservoir chamber of the pressure medium reservoir when the piston is in a non-actuated position.

8. The brake system as claimed in claim 1, wherein the brake system comprises one electrically actuatable outlet valve per output port, wherein the outlet valves are connected via a return line to the first port of the pressure medium reservoir.

9. The brake system as claimed in claim 8, wherein the replenishment port is connected via the replenishment valve to the return line.

10. The brake system as claimed in claim 1, wherein a spring of the replenishment valve is dimensioned such that the replenishment valve is not opened by a hydrostatic pressure in the first reservoir chamber.
